(19) United States
(12) Patent Application Publication
(10) Pub. No.: US 2012/0002729 A1
(43) Pub. Date: Jan. 5, 2012

(54) METHOD AND APPARATUS FOR LOW COST COEFFICIENT-SUPPRESSION FOR VIDEO COMPRESSION

(75) Inventor: Akira Osamoto, Plano, TX (US)

(73) Assignee: TEXAS INSTRUMENTS INCORPORATED, Dallas, TX (US)

(21) Appl. No.: 13/150,986

(22) Filed: Jun. 1, 2011

Related U.S. Application Data
(60) Provisional application No. 61/360,015, filed on Jun. 30, 2010.

(51) Int. Cl. H04N 7/26

(52) U.S. Cl. 375/240.24; 375/E07.076

(57) ABSTRACT

A method for video compression and a video encoder. The method for video compression includes finding a coefficient relating to inter-coded block with a biggest absolute value, determining the number of non-zero coefficients when the absolute value is less that 2, determining the number of non-zero coefficients is less than a threshold, and setting the coefficients to zero when the non-zero coefficients is less than the threshold.

### CROSS-REFERENCE TO RELATED APPLICATIONS

This application claims benefit of U.S. provisional patent application Ser. No. 61/360,015, filed Jun. 30, 2010, which is herein incorporated by reference.

### BACKGROUND OF THE INVENTION

1. Field of the Invention

Embodiments of the present invention generally relate to a method and apparatus for low cost expensive coefficient suppression algorithm for video compression.

2. Description of the Related Art

Suppressing expensive coefficients after quantization affects the video quality. Also, conventional suppression algorithm requires zig-zag scanning of the quantized coefficients and weighting of each zero-run, which may be computationally expensive or may increase the hardware scale to support such an algorithm.

For example, H.264 committee software developed has an algorithm that suppresses ‘expensive’ coefficients. Such software considers one or very few non-zero coefficients with its absolute level of 1 as expensive coefficients, in terms of bit usage, and sets them to zero. This algorithm contributes to high quality picture; however, the related hardware accelerator usually does not have such functionality. This results in a lacking function, which can not be compensated due to the current architecture.

Therefore, there is a need for a simpler method for video compensation with comparable video quality, which enables a more efficient implementation and/or more compact hardware.

### SUMMARY OF THE INVENTION

Embodiments of the present invention relate to a method for video compression and a video encoder. The method for video compression includes finding a coefficient relating to inter-coded block with a biggest absolute value, determining the number of non-zero coefficients when the absolute value is less that 2, determining the number of non-zero coefficients is less than a threshold, and setting the coefficients to zero when the non-zero coefficients is less than the threshold.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram depicting an embodiment of a method for video compression relating to luminance blocks;

FIG. 2 is a flow diagram depicting an embodiment of a method for video compression relating to chrominance blocks;

FIG. 3 is an embodiment of a block diagram of H.264 that includes an expensive coefficient suppression;

FIG. 4 is an embodiment of a conventional scheme for Luma 4×4 Transform; and

FIG. 5 is an embodiment of an improved scheme for Luma 4×4/8×8 Transform.

### DETAILED DESCRIPTION

This document summarizes the impact of the lack of the expensive coefficients suppression on picture quality for future enhancement. A simplified algorithm is also proposed for a feasible implementation.

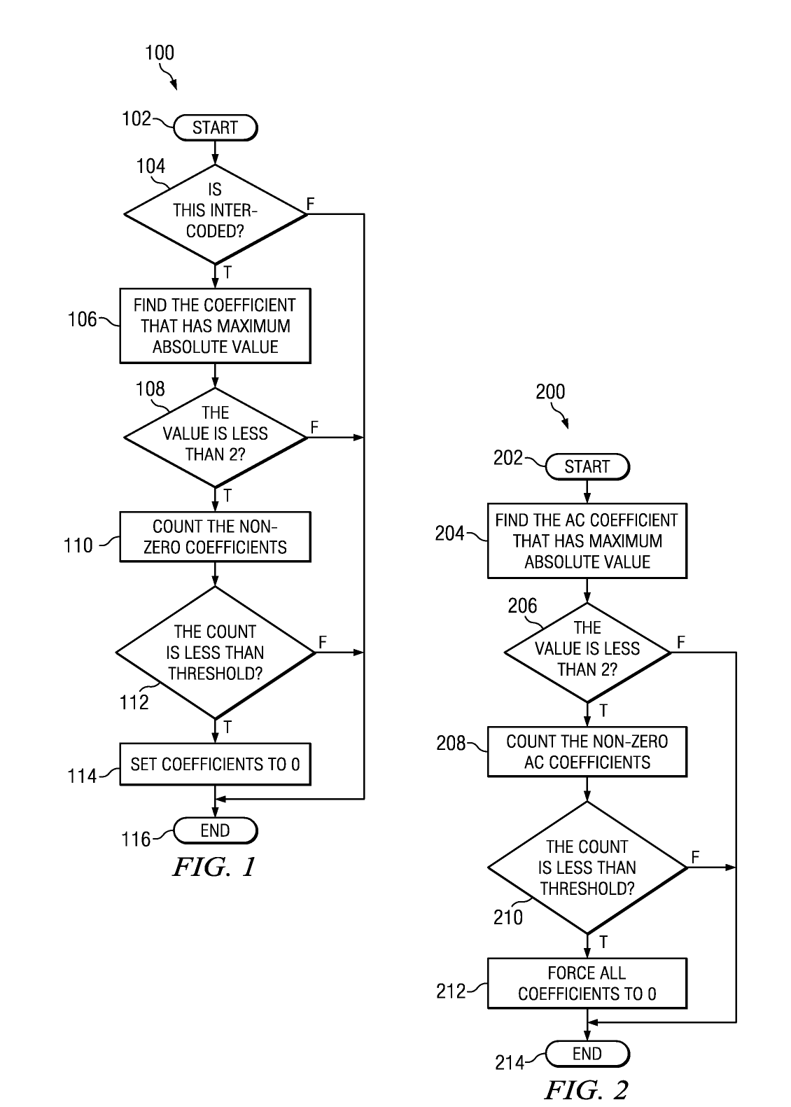

FIG. 1 is a flow diagram depicting an embodiment of a method 100 for video compression relating to a luminance block. The method 100 starts at 102 and proceeds to step 104. At step 104 the method 100 determines if the block is inter-coded. If the block is not inter-coded the method 100 proceeds to step 116 without modifying any coefficients in the block. If the block is inter-coded, the method 100 proceeds to step 106. In step 106, the method 100 retrieves the coefficient (including DC and AC) that has the maximum absolute value. At step 108, the method 100 determines in the coefficient's value is not less than 2, if the value is less than 2, the method 100 proceeds to step 116 without modifying any coefficients in the block. If the value is less than 2, the method 100 proceeds to step 110. In step 110, the method 100 counts the non-zero coefficients in the block. At step 112, the method 100 determines if the count is less than a threshold. If the count is not less than the threshold, the method 100 proceeds to step 116 without modifying any coefficients in the block. If the count is less than the threshold, the method 100 proceeds to step 114. At step 114, the method 100 sets all of the coefficients in the block to zero. The method 100 ends at step 116.

FIG. 2 is a flow diagram depicting an embodiment of a method 200 for video compensation relating to a chrominance block. The method 200 starts at step 202 and proceeds to step 204. At step 204, the method 200 finds the AC coefficient that has the highest absolute value. At step 206, the method 200 determines if the value is less than 2. If the value is not less than 2, then the method 200 proceeds to step 214. If the value is less than 2, the method 200 proceeds to step 208, wherein the method 200 counts the non-zero AC coefficient and the method proceeds to step 210. At step 210, the method determines if the count is less than a threshold. If the count is not less than the threshold, the method 200 proceeds to step 214. Otherwise, the method 200 proceeds to step 212. At step 212, the method 200 forces all AC coefficients to zero. The method 200 ends at step 214.

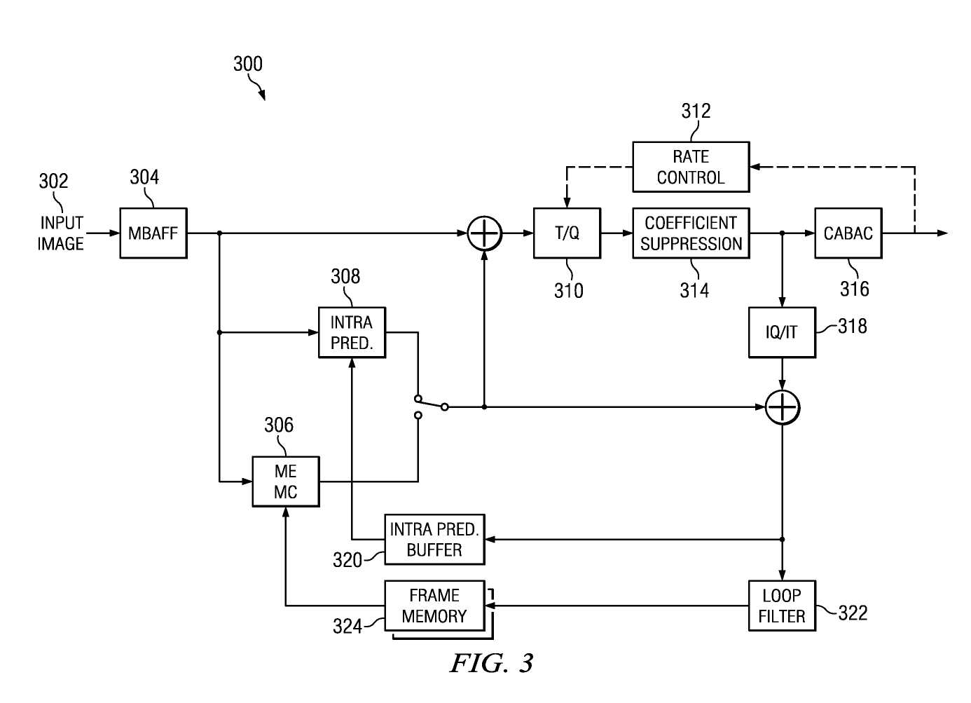

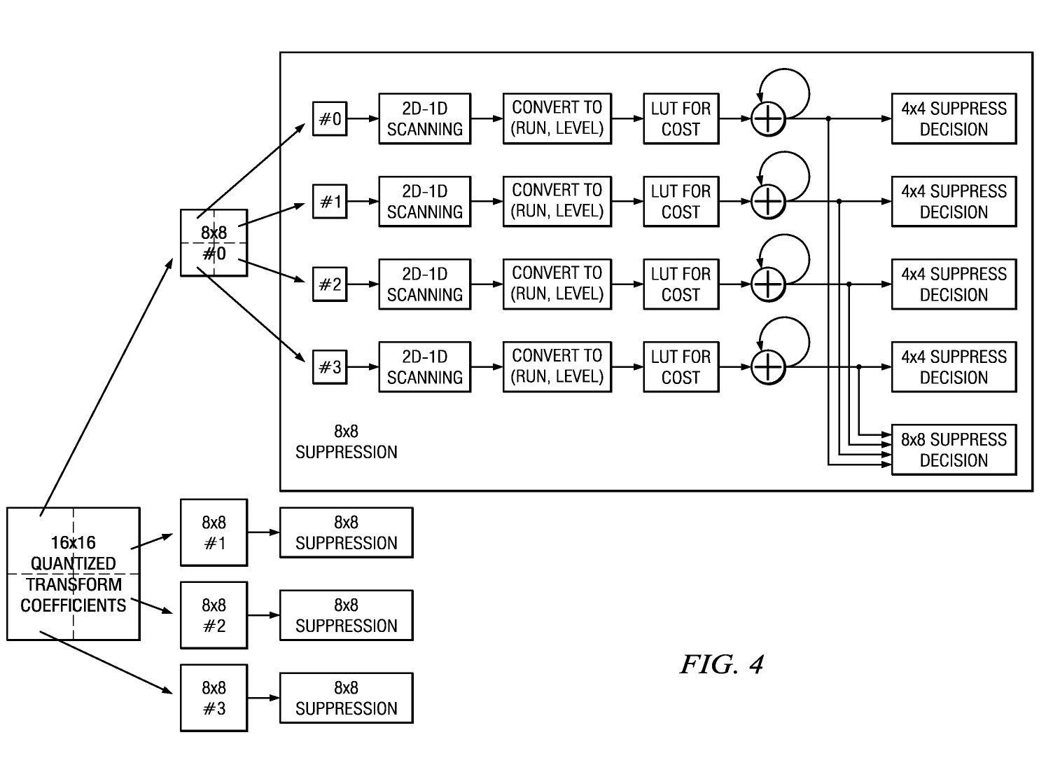

FIG. 3 is an embodiment of a block diagram of a video encoder. A macroblock-adaptive field-frame coding (MBAFF) 304 decides the macroblock mode, such as, frame or field, and retrieves a macroblock from an input image 302. The motion estimation (ME) 306 finds the optimum motion vector for inter-prediction by using the stored reconstructed previous images. The intra prediction module 308 determines the optimum intra-prediction mode utilizing the buffered reconstructed current image. The inter- or intra-prediction is subtracted from the original macroblock. Transformer/quantizer (T/Q) 310 performs the forward transform and quantization. In one embodiment, the quantization parameter is given from a Rate Controller 312 to achieve the target bitrate.

The quantized coefficient output from T/Q 310 is utilized by a Coefficient Suppression 314, which removes expensive coefficients to get better video quality in the given bitrate constraint. After Coefficient Suppression 314, the quantized coefficients go into context-adaptive binary arithmetic coding (CAMAC) 316 and inverse quantization and inverse transform (IQ/IT) 318 to get the reconstructed residual signal. The inter- or intra-prediction is added to this residual in order to get the reconstructed macroblock. This is stored in the intra-prediction buffer 320 for subsequent macroblocks. The same reconstructed macroblock is also loop-filtered by a Loop Filter 322 and stored in the frame memory 324 for inter-prediction for future frames (or fields).

For a luminan of a 4×4 transform, it may happen that for instance a macroblock has one nonzero coefficient with |Level|=1. This will probably be a very “expensive” coefficient in terms of bit usage. Hence, it maybe beneficial to set it to zero. For that reason a procedure to check single coefficient has been used for inter luma blocks. During the quantization process, a parameter is accumulated depending on Run and Level according to the following rule that if the Level=0 or (|Level|=1 and Run>5) nothing is added to the parameter, for example, Single_ctr. However, if |Level|>1, then a 9 is added to Single_ctr. Whereas, if |Level|=1 and Run<6, a value T(Run) is added to Single_ctr, where T(0:5)=(3, 2, 2, 1, 1, 1). If the accumulated parameters for a 8×8 block is less than 4, all coefficients of that luma block are set to zero. Similarly, if the accumulated Single_ctr for the whole macroblock is less than 6, all coefficients of that luma macroblock are set to zero.

For chrominance, a similar method to the one for luma is used. The parameter, for example, Single_ctr is calculated similarly for each chroma component, which would only include for AC coefficients and for the whole macroblock. If the accumulated Single_ctr for each chroma component of a macroblock is less than 7, all the AC chroma coefficients of that component for the whole macroblock are set to zero.

For luminance of an 8×8 transform, if the Level=0 or (|Level|=1 and Run>20) nothing is added to a parameter, for example, Single_ctr. If |Level|>1, 9 is added to Single_ctr. If |Level|=1 and Run<21, a value T(Run) is added to Single_ctr. where T(0:20)=(3, 3, 3, 3, 2, 2, 2, 2, 2, 2, 2, 2, 1, 1, 1, 1, 1, 1, 1, 1, 1, 1, 1, 1). But if the accumulated Single_ctr for a 8×8 block is less than 4, all coefficients of that luma block are set to zero. Similarly, if the accumulated Single_ctr for the whole macroblock is less than 6, all coefficients of that luma macroblock are set to zero.

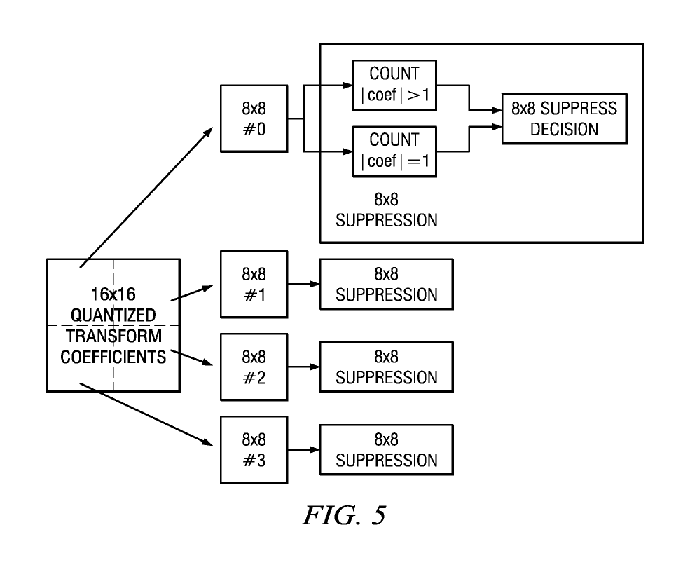

An improved algorithm is proposed in FIG. 5. For each 8×8 chrominance block, all of 60 AC coefficients, which is less 4 coefficients from the 64, are also set to zero when all of AC coefficients are −1, 0, or +1 and the number of AC coefficients that values are +1 or −1 in the block is N or fewer. It can be paraphrased as “the sum of absolute AC coefficients in the block is at most N.” Note that both intra and inter-coded block are eligible for chrominance blocks, unlike luminance blocks. N is a pre-determined constant; it is set to 1, 2 or 3 in this report. It could be different from the constant for luminance.

While the foregoing is directed to embodiments of the present invention, other and further embodiments of the invention may be devised without departing from the basic scope thereof, and the scope thereof is determined by the claims that follow.

1. A method of a video encoder for video compensation, comprising:
finding a coefficient relating to inter-coded block with a biggest absolute value;
determining the number of non-zero coefficients when the absolute value is less that 2;
determining the number of non-zero coefficients is less than a threshold; and
setting the coefficients to zero when the non-zero coefficients is less than the threshold.

2. The method of claim 1 further comprising:
finding an AC coefficient that has the highest absolute value;
determining the count of non-zero AC coefficient when the absolute value is greater that 2; and
forcing AC coefficient to zero when the count is less than the threshold.

3. A video encoder, comprising:
means for finding a coefficient relating to inter-coded block with a biggest absolute value;
means for determining the number of non-zero coefficients when the absolute value is less that 2;
means for determining the number of non-zero coefficients is less than a threshold; and
setting the coefficients to zero when the non-zero coefficients is less than the threshold.

4. The video encoder of claim 3 further comprising:
means for finding an AC coefficient that has the highest absolute value;
means for determining the count of non-zero AC coefficient when the absolute value is greater that 2; and
means for forcing AC coefficient to zero when the count is less than the threshold.

5. A non-transitory storage medium comprising computer instructions, when executed perform a method for video compensation, comprising:
finding a coefficient relating to inter-coded block with a biggest absolute value;
determining the number of non-zero coefficients when the absolute value is less that 2;
determining the number of non-zero coefficients is less than a threshold; and
setting the coefficients to zero when the non-zero coefficients is less than the threshold.

6. The non-transitory storage medium of claim 5 further comprising:
finding an AC coefficient that has the highest absolute value;
determining the count of non-zero AC coefficient when the absolute value is greater that 2; and
forcing AC coefficient to zero when the count is less than the threshold.
